(19) United States
(12) Patent Application Publication
(10) Pub. No.: US 2009/0114419 A1
(43) Pub. Date: May 7, 2009

(54) GAP-TYPE OVERHEAD TRANSMISSION LINE AND MANUFACTURING METHOD THEREOF

(75) Inventors: Hyun-ho Park, Gyeonbuk (KR); Sung-yul Park, Gyeongbuk (KR); Sung-wook Kim, Gyeongbuk (KR); Sung-ik Shim, Gyeongbuk (KR)

Correspondence Address: JONES DAY, 222 EAST 41ST ST, NEW YORK, NY, 10017, US

(73) Assignee: L S Cable Ltd.

(21) Appl. No.: 11/719,695

(22) PCT Filed: Jan. 9, 2006
(86) PCT No.: PCT/KR2006/000081

§ 371 Date: May 18, 2007

(30) Foreign Application Priority Data
Mar. 11, 2005 (KR) 10-2005-0020708

(51) Int. Cl. H01B 7/00; H01R 43/033

(52) U.S. Cl. 174/113 R; 29/825

(57) ABSTRACT

A gap-type overhead transmission line includes a steel core member; a conductor layer positioned to surround the steel core member and having at least one strand wire aggregated therein; and a coating layer interposed in a solid state between the steel core member and the conductor layer so as to surround the steel core member, the coating layer including a material that is sublimated after the conductor layer is stranded so as to form a predetermined gap between the steel core member and the conductor layer.

### TECHNICAL FIELD

The present invention relates to a gap-type overhead transmission line and its manufacturing method. and more particularly to an overhead transmission line configured to have a gap between a steel core and a conductor and its manufacturing method.

### BACKGROUND ART

Generally, an overhead transmission line such as an overhead power cable, an overhead branch line and OPGW (Optical Ground Wire) is constructed using electric poles or transmission towers, and its temperature is changed depending on external environments such as atmospheric temperature, wind and solar light, and current flowing through the line. Such temperature change causes contraction and expansion of the line, which results in change of sag of the overhead transmission line. Thus, considering the sag of the overhead transmission line, a tension between transmission towers is controlled or an electric spacing distance from the ground is determined. That is to say, a maximum allowable current of an overhead transmission line is limited due to the sag of the line.

In order to decrease or restrain sag of the overhead transmission line, there are used two methods in brief: namely LTACSR (Loose Type Aluminum Conductor Steel Reinforced) and GTACSR (Gap Type Aluminum Conductor Steel Reinforced).

The loose-type overhead transmission line is configured so that common aluminum cable steel reinforced is prepared and then a gap is mechanically formed between the steel core and the aluminum strand wire during installation so as to share a tension with the steel core. In addition, the gap-type overhead transmission line is configured so that a gap is formed between the steel core and the aluminum strand wire when the line is produced.

FIGS. 1 and 2 are schematic views showing an example of a conventional overhead transmission line manufacturing method respectively.

Referring to FIGS. 1 and 2, in the conventional method, after a tension is previously applied to a steel core 1, the tension is removed to make the line loose, which is so-called ‘Pre-stretched conductor’, as disclosed in Japanese Patent Publication No. 2000-353425. However, this method has a drawback that a loose rate of the line is likely to disappear due to a restoring force of an aluminum strand wire 2 after the line is produced or while the line is installed.

FIG. 3 is a schematic view showing another example of a manufacturing method of a conventional overhead transmission line.

Referring to FIG. 3, in this method, after a steel core 11 is stranded, a spacer 16 is wound around the steel core 11 prior to stranding conductors 14, 15 so that gaps between the steel core 11 and the conductors 14, 15 are kept, as disclosed in Japanese Patent Publication No. 2000-207957. It is called GTACSR. However, this method has drawbacks of deteriorated working speed and increased product costs since the process of winding the spacer 16 around the steel core 11 is added. In addition, this method has a problem of using a high-strength steel core in addition to increase of the entire outer diameter and weight.

### DISCLOSURE OF INVENTION

### Technical Problem

The present invention is designed in consideration of the above problems, and therefore it is an object of the invention to provide a gap-type overhead transmission line configured so that a gap is formed using a sublimate material between a steel core and a conductor, and its manufacturing method.

### Technical Solution

In order to accomplish the above object, the present invention provides a gap-type overhead transmission line, which includes a steel core member; a conductor layer positioned to surround the steel core member and having at least one strand wire aggregated therein; and a coating layer interposed in a solid state between the steel core member and the conductor layer so as to surround the steel core member, the coating layer including a material that is sublimated after the conductor layer is stranded so as to form a predetermined gap between the steel core member and the conductor layer.

Preferably, the coating layer has a thickness of 0.1 mm to 10 mm.

Preferably, the coating layer includes naphthalene, dry ice or ice.

Preferably, a loose rate of the steel core member and the conductor layer is in the range of 0.1 to 0.5%.

In another aspect of the present invention, there is also provided a method for manufacturing a gap-type overhead transmission line, which includes (a) providing a steel core member; (b) forming a coating layer of a predetermined thickness with a sublimate material so as to surround the steel core member; (c) stranding a conductor layer having at least one strand wire aggregated therein around the coating layer; and (d) forming a predetermined gap between the steel core member and the conductor layer by means of phase change of the coating layer.

Preferably, the sublimate material includes naphthalene, dry ice or ice.

Preferably, the coating layer has a thickness of 0.1 mm to 10 mm.

Preferably, in the step (c), a preformed strand wire is stranded.

Preferably, after the step (d), a loose rate of the steel core member and the conductor layer is in the range of 0.1 to 0.5%.

### BRIEF DESCRIPTION OF THE DRAWINGS

FIGS. 1 and 2 are schematic views showing a conventional method for manufacturing an overhead transmission line respectively;

FIG. 3 is a schematic view showing another example of a conventional manufacturing method of an overhead transmission line;

FIGS. 4 to 7 are sectional views subsequently showing a method for manufacturing a gap-type overhead transmission line according to a preferred embodiment of the present invention.

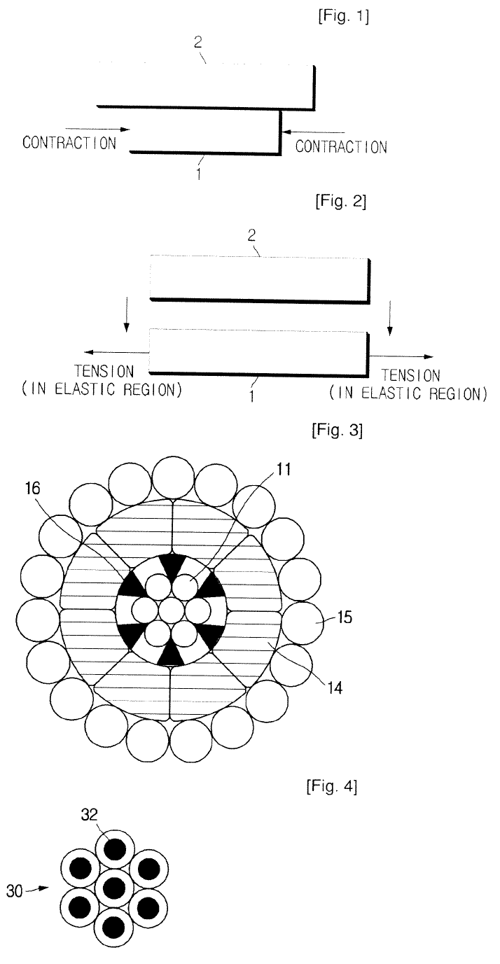

### BEST MODE FOR CARRYING OUT THE INVENTION

Hereinafter, a preferred embodiment of the present invention will be described in detail with reference to the accompanying drawings.

FIGS. 4 to 7 are sectional views showing a method for manufacturing a gap-type overhead transmission line according to a preferred embodiment of the present invention, respectively.

First, as shown in FIG. 4, a steel core member 30 is prepared. The steel core member 30 is preferably configured so that seven steel core strand wires 32 having aluminum cladding are stranded in a predetermined shape (7-core strand wires). Here, the number, shape and material of the steel core strand wires 32 may be changed depending on capacity of the overhead transmission line or the like. The cladding and stranding processes may adopt conventional ones.

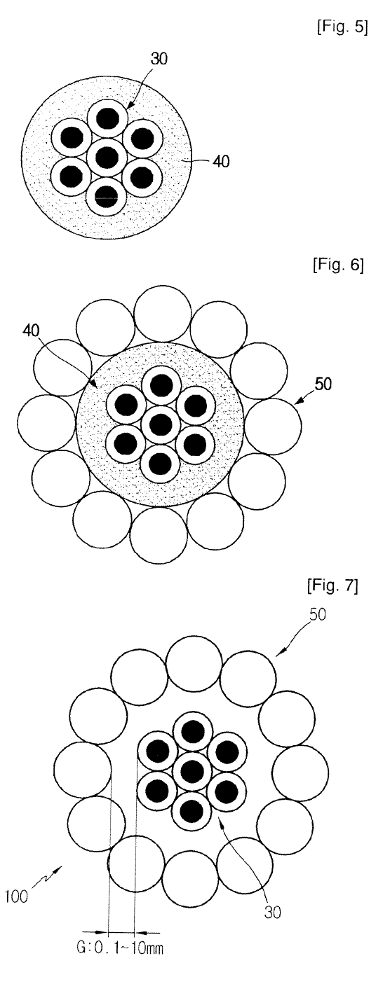

Subsequently, as shown in FIG. 5, sublimate material such as naphthalene, dry ice or ice is coated around the steel core member 30 having 7-core strand wire structure to form a coating layer 40. The coating layer 40 has a thickness identical to a width of the gap G between the steel core member 30 and the conductor layer 50 as described later, and this thickness should be suitably selected. The coating layer 40 preferably has a thickness of 0.1 mm to 10 mm. In case the coating layer 40 has a thickness less than 0.1 mm, the gap generated by the coating layer 40 has a small width, so improvement of performance of the overhead transmission line is not expected. In case the thickness is greater than 10 mm, an outer diameter of the overhead transmission line is increased, so it is very difficult to apply the overhead transmission line. For example, reinforcement of existing towers is required. Here, an optimal thickness of the coating layer 40 is about 0.6 mm. This value may maximize the performance of the overhead transmission line together with minimizing increase of its outer diameter. Here, the thickness of the coating layer is defined as a thickness of the coating layer at an outermost portion of the steel core member 30.

Then, as shown in FIG. 6, a conductor is stranded around the coating layer 40 to form a conductor layer 50. Aluminum or its alloys such as H-1350, AA6201, TAL and STAL may be preferably used for forming the conductor layer 50. In addition, the conductors used for forming the conductor layer 50 preferably employ preformed strand wires. This prevents the conductor strand wires from getting loose when being stranded. For the preforming work, a common method is used. Meanwhile, the number of layers of the stranded conductor layer 50 may be adjusted as desired according to a necessary capacity of an overhead transmission line.

If a predetermined time passes after the above processes, the sublimate material in the coating layer 40 disappears due to phase change, and a gap G is formed between the steel core member 30 and the conductor layer 50 as much as an exhausted amount of the coating layer 40, as shown in FIG. 7.

A loose rate of the overhead transmission line 100 formed as mentioned above (which is defined as a length of surplus conductor in comparison to the steel core) is preferably in the range of 0.1% to 0.5%.

If the loose rate is less than 0.1%, sag of the overhead transmission line caused by its looseness is not effectively prevented. If the loose rate is greater than 0.5%, a birdcage phenomenon (a phenomenon in which strand wires become wider like a birdcage when gaps between strand wire layers are great) may occurs during stranding or installation.

### INDUSTRIAL APPLICABILITY

As described above, the gap-type overhead transmission line and its manufacturing method according to the present invention may reduce or restrain sag of an overhead transmission line by forming a gap using a coating layer made of sublimate material between a steel core member and a conductor layer, and thus a transmission capacity of the overhead transmission line may be increased.

In addition, since a tension is not previously applied to the steel core member or the conductor layer, a loose rate is not exhausted after wire manufacturing or during installation. Moreover, after the coating layer is formed, there is no need of addition process in order to form a gap, so it is possible to increase a working speed and prevent increase of a product cost.

1. A gap-type overhead transmission line, comprising:
a steel core member;
a conductor layer positioned to surround the steel core member and having at least one strand wire aggregated therein; and
a coating layer interposed in a solid state between the steel core member and the conductor layer so as to surround the steel core member, the coating layer including a material that is sublimated after the conductor layer is stranded so as to form a predetermined gap between the steel core member and the conductor layer.

2. The gap-type overhead transmission line according to claim 1, wherein the coating layer has a thickness of 0.1 mm to 10 mm.

3. The gap-type overhead transmission line according to claim 1 or 2, wherein the coating layer includes naphthalene, dry ice or ice.

4. The gap-type overhead transmission line according to claim 1 or 2, wherein a loose rate of the steel core member and the conductor layer is in the range of 0.1 to 0.5%.

5. A method for manufacturing a gap-type overhead transmission line, comprising:
(a) providing a steel core member;
(b) forming a coating layer of a predetermined thickness with a sublimate material so as to surround the steel core member;
(c) stranding a conductor layer having at least one strand wire aggregated therein around the coating layer; and
(d) forming a predetermined gap between the steel core member and the conductor layer by means of phase change of the coating layer.

6. The method for manufacturing a gap-type overhead transmission line according to claim 5,
wherein the sublimate material includes naphthalene, dry ice or ice.

7. The method for manufacturing a gap-type overhead transmission line according to claim 5 or 6,
wherein the coating layer has a thickness of 0.1 mm to 10 mm.

8. The method for manufacturing a gap-type overhead transmission line according to claim 5 or 6,
wherein, in the step (c), a preformed strand wire is stranded.

9. The method for manufacturing a gap-type overhead transmission line according to claim 5 or 6,
wherein, after the step (d), a loose rate of the steel core member and the conductor layer is in the range of 0.1 to 0.5%.
